(19) United States
(12) Patent Application Publication
(10) Pub. No.: US 2009/0191522 A1
(43) Pub. Date: Jul. 30, 2009

(54) Colorized optical learning or reinforcement

(75) Inventors: Thomas P. McClain, Ridgefield, CT (US); Jeffrey Alan McChesney, Ridgefield, CT (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Venture Capital & Consulting Group, LLC, Ridgefield, CT (US)

(21) Appl. No.: 12/321,614

(22) Filed: Jan. 23, 2009

Related U.S. Application Data
(60) Provisional application No. 61/062,158, filed on Jan. 24, 2008.

(51) Int. Cl. G09B 1/00

(52) U.S. Cl. 434/170

(57) ABSTRACT

There is provided a method that includes (a) obtaining a result of a test of a person, wherein the result indicates a color for which the person has an affinity, and (b) preparing a document that includes an element having a feature having the color.

### CROSS-REFERENCE TO RELATED APPLICATIONS

The present application is claiming priority of U.S. Provisional Patent Application Ser. No. 61/062,158, filed on Jan. 24, 2008, the content of which is herein incorporated by reference.

### BACKGROUND OF THE INVENTION

1. Field of the Invention

The present application is directed to a reading education tool, and more specifically, a reading education tool that utilizes a person's affinity for a particular color to emphasize certain aspects of material that is being presented to the person.

2. Description of the Related Art

Today, there is a limited ability of current reading systems to improve comprehension and retention of a key letter, syllable, word, numeral, shape, image, sign or symbol (hereafter referred to as “Letter, et al.”) and their respective meanings. Many methods have been unsuccessful at truly accelerating a reader's comprehension and retention. In particular, there is/are:
1. no ability to directly associate Letter, et al to a person's optical preference and affinity for reading and learning;
2. no ability for testing a specific person for color affinity for the purposes of learning to read and comprehend;
3. no ability to use specific color affinity of a person to increase comprehension and learning to read;
4. a lack of ability to associate a person's color affinity with a visually recognized Letter, et al to increase comprehension and learning to read;
5. no use of a color filter, using a person's affinity for a specific color, to optically increase reader comprehension, learning and retention;
6. no combined use of a color filter, image and a person's specific affinity for a specific color, to visually increase reader comprehension, learning and retention;
7. a lack of using color affinity testing with a specific person to create a color filter, highlight and font that will visually increase reader comprehension, learning and retention; and
8. no system that tests a specific person for color affinity and then provides a combined use of a color filter, highlight, a Letter, et al from any language and a related image to visually increase reader comprehension, learning and retention.

### SUMMARY OF THE INVENTION

In a system and method described herein and referred to as the Colorized Optical Learning Or Retention System (COLORS), not only are these problems solved, but also many new opportunities are created. The method includes (a) obtaining a result of a test of a person, wherein the result indicates a color for which the person has an affinity, and (b) preparing an electronic or physical document that includes an element having a feature having the color.

Now, particular readers will have the ability to associate personally tested affinity colors with a Letter, et al that may include a physical print media or digital display, with a related image to increase comprehension, learning and retention. For example, a new reader is tested for preferences and affinity to a color through a process of selection and/or elimination using color charts, shapes and objects either with physical or digital media. Using the specific affinity color, Letter, et al would be optically filtered or highlighted, or shown as a font in that specific color, and may be directly followed by a visual image of that word. As another example, the target word could be “dog,” highlighted in the tested person's affinity color of bright yellow with a black colored font, directly followed by an image or picture of a dog, which may also be in the affinity color. A plurality of Letter, et al, selected for learning comprehension and retention to increase reading ability, could be aggregated with the reader's specific affinity color and respective images, and then aggregated into lists, sentences, paragraphs, chapters, volumes and books or mathematical exercises, either physically or digitally displayed. The COLORS enables:
1. a person to use a specific color affinity to accelerate learning to read;
2. a person to use a specific color affinity and visual image to increase comprehension, learning and retention;
3. creation of a system to test a person for a specific color preference or affinity and then to use it with Letter, et al to increase comprehension, learning and retention;
4. visually appealing Letter, et al, lists, sentences, paragraphs, chapters, volumes or books that a specific person can use to accelerate reading comprehension, learning and retention;
5. specifically customized reading materials for each specific person; and
6. creation of a reading system, either physical or digital, for accelerated comprehension, learning and retention.

### BRIEF DESCRIPTION OF THE DRAWINGS

FIG. 1 is a block diagram of a system that provides to a target recipient or reader, physical or digital media using the target recipient's preferred color(s) to accelerate reading comprehension, learning and retention.

FIG. 2 is an example of a reading system that employs a selected color preference to emphasize a key word.

FIG. 3 is an example of a reading system that employs a selected color preference to emphasize a key image.

FIG. 4 is an example of a reading system that employs a selected color preference to emphasize key words or mathematical expressions with corresponding images.

FIG. 5 is a flowchart of a process that employs the system of FIG. 1.

FIG. 6 is an example of a reading passage produced by the system of FIG. 1.

FIG. 7 is an example of a reading passage produced by the system of FIG. 1.

FIG. 8 (represented in two parts designated as FIG. 8a and FIG. 8b) is an example of a reading passage produced by the system of FIG. 1.

FIG. 9 is an example of a kit for a color preference selection test.

### DESCRIPTION OF THE INVENTION

A technique described herein involves the use of selected preferred colors to Letter, et al in physical or digital (e.g., electronic) media. The technique is particularly suitable for children's books in physical and digital forms; however, it is also suitable for other types of books in physical and digital form for accelerating reading comprehension, learning and retention.

The technique takes advantage of knowledge that a target recipient of a book prefers a specific color or colors, the preference being obtained directly from the target recipient via a color preference testing selection process. Such color preference selection process can be obtained, for example, from a color test involving words, forms, shapes or physical images presented in various colors either in physical or digital instantiations. The target recipient chooses the word, form, shape or physical image from a selection of the words, forms, shapes or physical images in various colors such that the target recipient's color preferences become apparent. A priority is then aligned with those color preferences. A simple example could be a color wheel, whether physical or digital, that is designed to help the target recipient choose between colors. In this example, the wheel itself allows a binary choice of color A or B. The selected color is then spun around to compare with another color C, and so on for a full range of colors. By repeating this process of elimination, the target recipient is able to select his/her preferred color. The target recipient does not necessarily need to understand the purpose of the selection test. Similar test methods have been developed for auditory and sight tests.

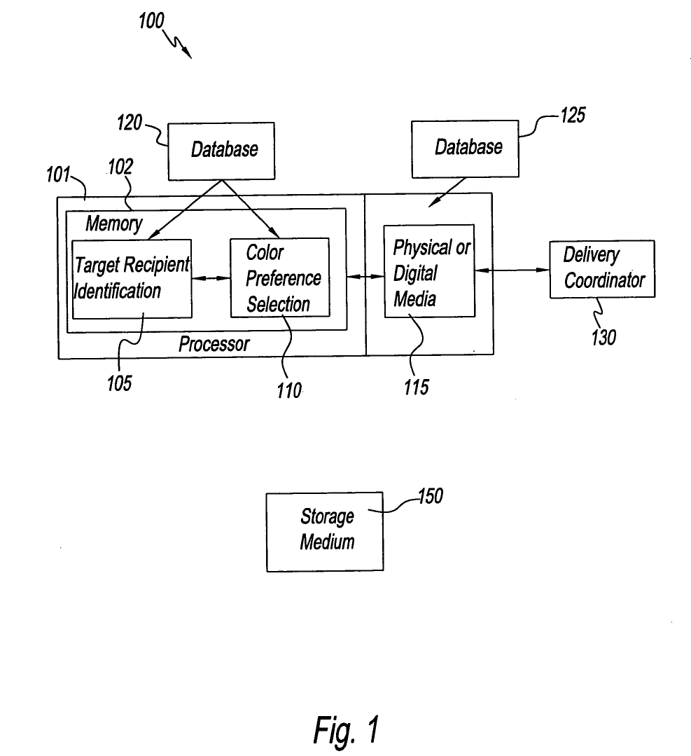

FIG. 1 is a block diagram of a COLORS system, i.e., system 100, that provides to a target recipient or reader, physical or digital media using the target recipient's preferred color(s) to accelerate reading comprehension, learning and retention. System 100 includes a computer processor, i.e., a processor 101, a database 120, a database 125, physical or digital media module 115, and a delivery coordinator module 130.

Processor 101 has associated therewith, a memory 102 that contains instructions that are readable by processor 101, and control processor 101 to perform activities described herein. In the embodiment shown in FIG. 1, memory 102 includes a target recipient identification module 105, and a color preference selection module 110. The term “module” is used herein to denote a functional operation that may be embodied either as a stand-alone component or as an integrated configuration of a plurality of sub-ordinate components.

Target recipient identification module 105 contains identity and personal information, such as address, phone number, parents' names, age, and email addresses, to create a record for a target recipient. In one example, the target recipient is a child, age 4, with information in the record about the parents' personal contact information. This information can be in physical or digital format.

Color preference selection module 110 contains representations of various physical or digital forms and shapes, in multiple different colors, that are presented to the target recipient for selection of preferred colors. The selections are then prioritized for further use to match colors with words and shapes for reading and comprehension. One example is a use as a vocabulary list with words and images side by side. Another example is a sentence or paragraph with selected words highlighted with colors and/or images to increase learning, comprehension and retention.

Physical or digital media module 115 contains books or software programs that present each key word with a corresponding image, using the target recipient's preferred colors, in physical or digital media.

Database 120 contains data from target recipient identification module 105 and color preference selection module 110, which includes the target recipient's personal information and preferred color(s), forming a target recipient's record.

Database 125 contains data about the target recipient's past and present physical or digital media products that have either been delivered, if in physical form, or sent, if in digital form. Database 125 records any usage or access metrics that have been acquired via the target recipient's use with the reading products.

Delivery coordinator module 130 contains data about forthcoming physical or digital products that will be delivered in the future to the target recipient.

System 100 may be implemented as a stand-alone system on a general-purpose computer. Alternatively, each of processor 101, database 120, database 125, physical or digital media module 115, and delivery coordinator module 130 may be implemented on a stand-alone system, and coupled to one another via a network (not shown). System 100 may also be implemented in a configuration of one or more circuits, that is, a configuration of electrically or electromagnetically connected components or devices, in hardware, firmware, or a combination thereof.

Also, although system 100 is described herein as having target recipient identification module 105 and color preference selection module 110 installed into memory 102, physical or digital media module 115, database 120, database 125 and delivery coordinator module 130 can also be installed into memory 102 so that system 100 is contained in a single stand-alone apparatus. Accordingly, memory 102 would then contain instructions readable by processor 101, and that control processor 101 to perform the functions of target recipient identification module 105, color preference selection module 110, physical or digital media module 115, database 120, database 125 and delivery coordinator module 130. Also, any or all of target recipient identification module 105, color preference selection module 110, physical or digital media module 115, database 120, database 125, or delivery coordinator module 130 can be tangibly embodied on an external computer-readable storage medium 150 for subsequent loading into memory 102. Storage media 150 can be any conventional storage media, including, but not limited to, a floppy disk, a compact disk, a magnetic tape, a read only memory, or an optical storage media. Storage media 150 could also be a random access memory, or other type of electronic storage, located on a remote storage system and coupled to processor 101.

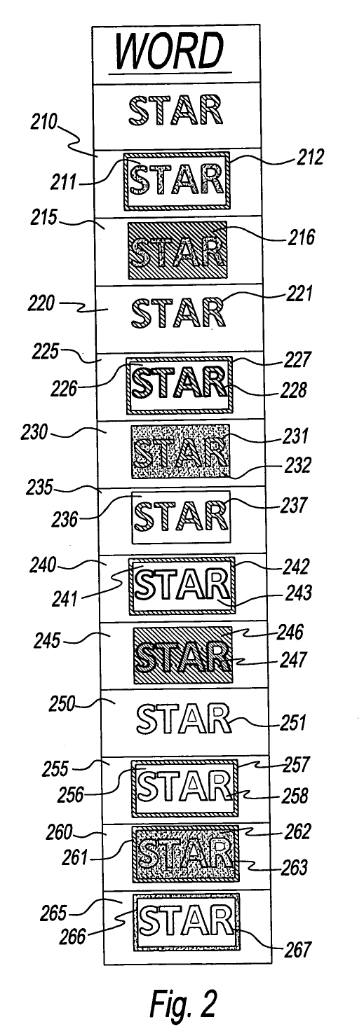

FIG. 2 is an example of a reading system that employs a selected color preference to emphasize a key word. The reading system has a goal of accelerating reading comprehension, learning and retention based on application of selected color preferences in a priority order to physical and/or digital media to place emphasis on key words contained in streams of text and images. In the example of FIG. 2, the key word is “STAR” and the preferred color is green.

Box 210 contains the word “STAR” in black text on a white background 211 encompassed by a green perimeter 212.

Box 215 contains the word “STAR” in black text on a green background 216.

Box 220 contains the word “STAR” in green text 221.

Box 225 contains the word “STAR” in green text 228 on a white background 226 encompassed by a green perimeter 227.

Box 230 contains the word “STAR” in green text 231 on a black background 232.

Box 235 contains the word “STAR” in green text 237 on a white background 236.

Box 240 contains the word “STAR” in text having a black outline 241 on a white background 243 encompassed by a green perimeter 242.

Box 245 contains the word “STAR” in green text having a black outline 247 on a green background 246.

Box 250 contains the word “STAR” in text having a green outline 251.

Box 255 contains the word “STAR” in text having a green outline 258 on a white background 256 encompassed by a green perimeter 257.

Box 260 contains the word “STAR” in black text having a green outline 263 on a black background 262 encompassed by a green perimeter 261.

Box 265 contains the word “STAR” in text having a green outline 267 on a background encompassed by a black perimeter 266.

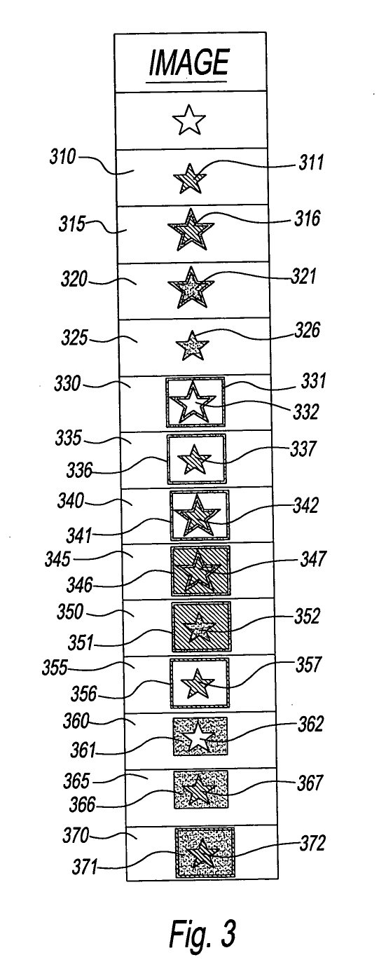

FIG. 3 is an example of a reading system that employs a selected color preference to emphasize a key image. The reading system has a goal of accelerating reading comprehension, learning and retention based on application of selected color preferences in a priority order to physical and/or digital media to place emphasis on key images contained in streams of text and images. In the example of FIG. 3, the key image is a star.

Box 310 contains an image of a star 311 having a green fill.

Box 315 contains an image of a star 316 having a green fill and a black outline.

Box 321 contains an image of a star 321 having a black fill and a green outline.

Box 325 contains an image of a star 326 having a black fill.

Box 330 contains an image of a star 332 having a black outline and white fill, on a white background encompassed by a black perimeter 331.

Box 335 contains an image of a star 337 having green fill, on a white background encompassed by a black perimeter 336.

Box 340 contains an image of a star 342 having a green fill with a black outline, on a white background encompassed by a black perimeter 341.

Box 345 contains an image of a star 347 having a green fill with a black outline, on a green background encompassed by a black perimeter 346.

Box 350 contains an image of a star 352 having a black fill, on a green background encompassed by a black perimeter 351.

Box 355 contains an image of a star 357 having a green fill, on a white background encompassed by a green perimeter 356.

Box 360 contains an image of a star 362 having a white fill, on a black background 361.

Box 365 contains an image of a star 367 having a green fill, on a black background 366.

Box 370 contains an image of a star 372 having a green fill, on a black background having a green perimeter 371.

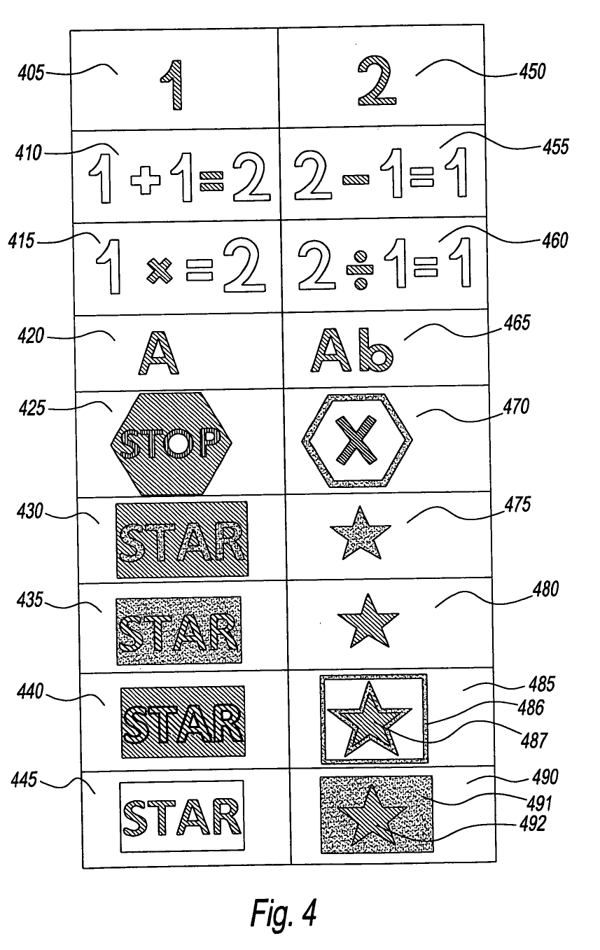

FIG. 4 is an example of a reading system that employs a selected color preference to emphasize key words or mathematical expressions with corresponding images. FIG. 4 combines one example from FIGS. 2 and 3, and adds a numeral sign, letter, syllable and shape, and has a goal of accelerating reading comprehension, learning and retention based on application of selected color preferences in a priority order to physical and/or digital media to place emphasis on key words with their corresponding images contained in streams of text and images.

Box 405 contains a numeral “1” that is green.

Box 410 contains an equation “1+1=2”, wherein the equal sign is green.

Box 415 contains an equation “1×2=2”, wherein the multiplication sign is green.

Box 420 contains a letter “A” that is green.

Box 425 contains an image of a stop sign, wherein the text “STOP” is red on a green background.

Box 430 contains the word “STAR” in black text on a green background.

Box 435 contains the word “STAR” in green text on a black background.

Box 440 contains the word “STAR” in green text, wherein each letter has a black outline, on a green background.

Box 445 contains the word “STAR” in green text on a white background.

Box 250 contains a numeral “2” that is green.

Box 455 contains an equation “2−1=1”, wherein the minus sign is green.

Box 460 contains an equation “2÷1=2”, wherein the division sign is green.

Box 465 contains a syllable “Ab” in green text.

Box 470 contains a green “X” on a white background, encompassed by a black hexagon-shaped perimeter.

Box 475 contains an image of a black star on a white background.

Box 480 contains an image of a green star on a white background.

Box 485 contains an image of a green star 487 having a black outline, on a white background encompassed by a black perimeter 486.

Box 490 contains an image of a green star 492 on a black background 491.

The attributes of FIG. 2 (WORD), FIG. 3 (IMAGE) and FIG. 4 (NUMERAL AND SIGN) include but are not limited to:
Alphabetical characteristics and numerals, in multiple languages;
Geometric shapes and or images, people, animals, places or things;
Mathematical signs of all types;
Open or closed spaces;
Color filled insides or outside;
Outlined or not outlined objects;
Illustrated or photographic images;
Solid or various color combinations of words or images; and
Single or multiple color combinations or words or images.
   Any single or multiple attributes may or may not be combined from FIGS. 2, 3 and 4, or from any variation not listed or included above.

The selected color preference is then used as an attention enhancement and affinity tool for a reader. For example, as a reader comes upon a word utilizing the selected color, the reader is expected to have greater attention and comprehension, especially if that word is also associated with a similarly colored picture immediately next to it. The increased color associations and attention helps with comprehension, and the color becomes a cueing mechanism for subsequent words.

For another example, referring to FIG. 1, a new reader is identified in target recipient identification module 105 and stored in database 120. Using a digital color wheel as color preference selection module 110, the reader selects a color preference, which is also stored in database 120. Based upon the identities and color preferences in database 120, selected prose, such as a children's book, is matched within database 125, and may include a match of recommended vocabulary words based on reader demographics and age. In physical or digital media module 115, the selected prose is then modified to associate key vocabulary words with the preferred color of the reader, in various formats as shown in FIG. 2. As a further example, for nouns, various pictures may be associated directly next to the key words, as shown in FIG. 3, for a resultant colorized word and picture display as shown in FIG. 4. All key words in the prose or children's book can then be modified by physical or digital media module 115 to provide colorized key words and their associated pictures. The reader's attention and retention will be enhanced by properly distributing the reformatted prose and pictures in delivery coordinator module 130, such as a newly printed children's book or training aid such as mathematical or reading flashcards, personalized directly to the preferences and needs of the reader stored in database 120. Additional books or flashcards, whether digital or physical, can then be produced for the reader and delivered by reusing system 100 multiple times.

One embodiment of the invention is to produce a physical children's book personalized with the color preferences of a pre-school reader. In this embodiment, a physical color selection preference kit is sent to the parents or guardian of the reader, with simple instructions to perform the color selection test. Upon completion, the parents or guardian register online the color selection of the reader, which age-specific and/or gender-specific book they want to personalize and select their demographic data, all stored into a database. Using the age and/or gender of the child, key vocabulary words are matched from another database that contains the vocabulary listings for the age in question. The digitized book is then scanned and modified to highlight the selected key words and add associated pictures next to these key words, with either one of them, or both, in the preferred color selection. A digital color printer then produces the personalized book and it is sent back to the parents or guardian. The reader then reads the book, or reads the book with the parent or guardian, and because of the selected preferred color and/or picture association now embedded in the book, the reader hopefully attains accelerated reading comprehension, learning and reinforcement. As each additional book is produced, the reader becomes much more accustomed to the color selection as a cueing mechanism for enhanced retention.

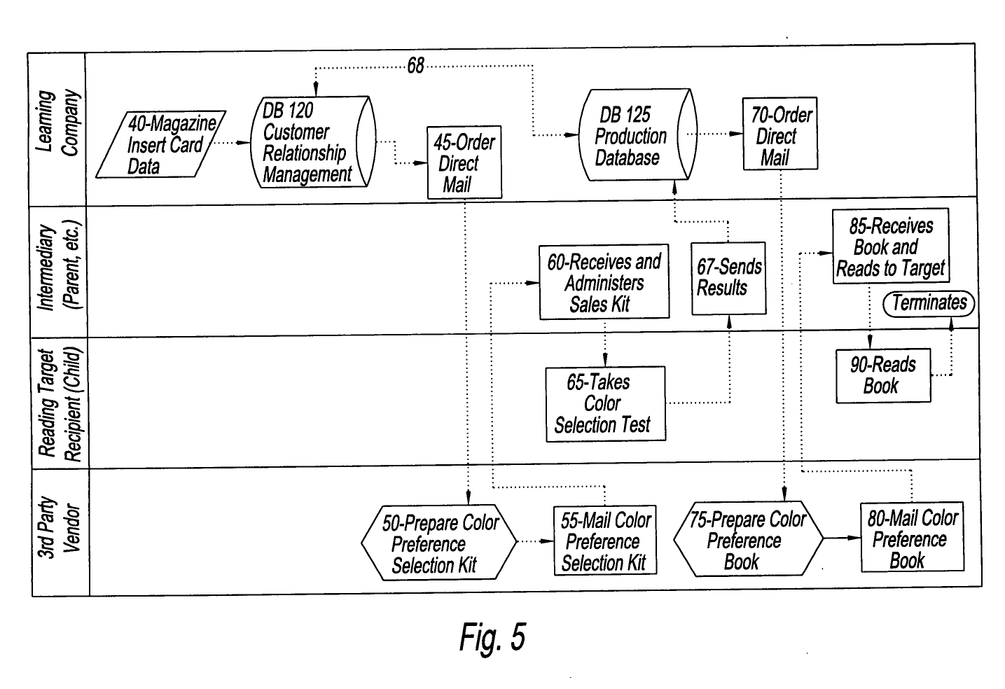

FIG. 5 is a flowchart of a process that employees system 100, and may involve, for example, lead acquisition through a magazine card insert. There are four major participants, namely (1) a Learning Company, (2) an Intermediary, which is typically a parent, (3) a Reading Target Recipient, and (4) a Third Party vendor.

A process 40 includes data and advertising responses from the Intermediary to use system 100, whether received by physical or digital means. These advertising responses initiate a digital sales order to database 120. Database 120 receives, processes and stores response data and the sales order from process 40, and sends instructions to a process 45 to order direct mail, with a return transmission to database 120 indicating that the order has been sent. Database 120 records the order progress, performs analytics and reporting. In addition, database 120 sends a transmission 68 to database 125 that a Color Preference Selection Kit has been requested by the Intermediary and to prepare for a purchase order.

Process 45 sends instructions, whether physical or digital, to a Third Party printer in a process 50.

Process 50 then prepares and creates the shipping order for the physical or electronic color preference kit, which may include ordering instructions and forms for the Intermediary. Process 50 then complies with the instructions from process 45 and sends the shipping order to a process 55.

Process 55 receives the shipping order, assembles the mailing materials and ships the Color Preference Selection Kit to the Intermediary to a process 60.

In process 60, the Intermediary receives the Color Preference Selection Kit and administers the kit to the Reading Target Recipient to a process 65.

In process 65, the Reading Target Recipient uses the Color Preference Selection Kit and selects a color preference that is then used as the basis for a process 67 to record the results and send the results back to the Learning Company.

In process 67, the Intermediary initiates a purchase order with the color preference and sends the direct mail response to database 125 for production. Database 125 sends a purchase order receipt, along with credit card or other financial obligation data to database 120 for customer relationship management functions and billing. Database 120 then processes the purchase order and credit card or other financial obligation data for approval to produce and ship a colorized book. If disapproved for purchase due to failure to obligate financial transactions, database 120 will inform database 125 through transmission 68 that the order has been denied. In turn, database 125, through process 67, informs the Intermediary of the denial and financial transaction failure.

If approved for payment processing, database 120 informs database 125 through transmission 68 to proceed with production of the purchase order. Database 120 then initiates payment and accounting processing from the Intermediary. Database 125 then produces the purchase order for direct mail of the colorized preference book, in the selected color ordered by the Intermediary, in a process 70. Process 70 then instructs a Third Party printer to produce a document, e.g., a color preference book, according to the approved purchase order along with production specifications from the Learning Company. For example, system 100 may issue a communication, e.g., an instruction in an electronic format, to a third party system, for the third party system to prepare the color preference book. The Third Party printer then fulfills the purchase order in process 75 and produces the book and shipping order.

Process 75 then instructs a process 80 to ship the book with a shipping order to the Intermediary. The shipping order is also sent electronically back to database 120 for recording. The Intermediary receives the book and shipping materials in a process 85. The Intermediary then reads the book to the Reading Target Recipient in a process 90 for learning and reinforcement, which terminates the process.

In another embodiment, FIG. 5 and all of the processes could be in a digital delivery system, to include color selections and delivery of the preferential colorized reading lessons as electronic books.

In another embodiment, the Intermediary and the Reading Target Recipient could be the same person or entity, such as an illiterate adult wanting to read.

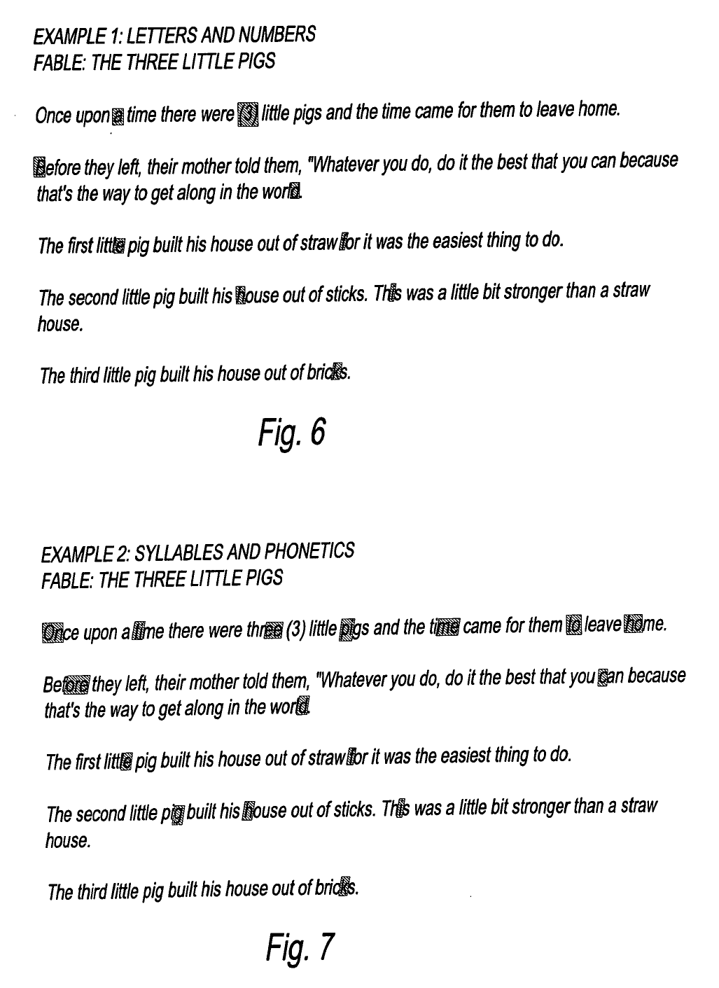

FIG. 6 is an example, namely Example 1, of a reading passage produced by system 100. In Example 1, system 100 indicates a first level of the colorized optical learning or reinforcement system for teaching an early reader to focus on the initial alphabet and numerals used in a language. Any language can be used, not just English, and not just the romantic languages. In FIG. 6, features having the reader's preferred color are represented by grayscale highlights. The features may be drafted from a lesson plan developed to assist early readers to highlight the specific learning objectives. The system produces the written display, whether physical or digital to the early reader. The reader is normally accompanied by a teacher or parent or assistant to ensure emphasis for each item, and may include verbalization through spoken sounds at each emphasis point. Due to the features delivered by the system in the preference of the reader, the reader has increased focus and attention.

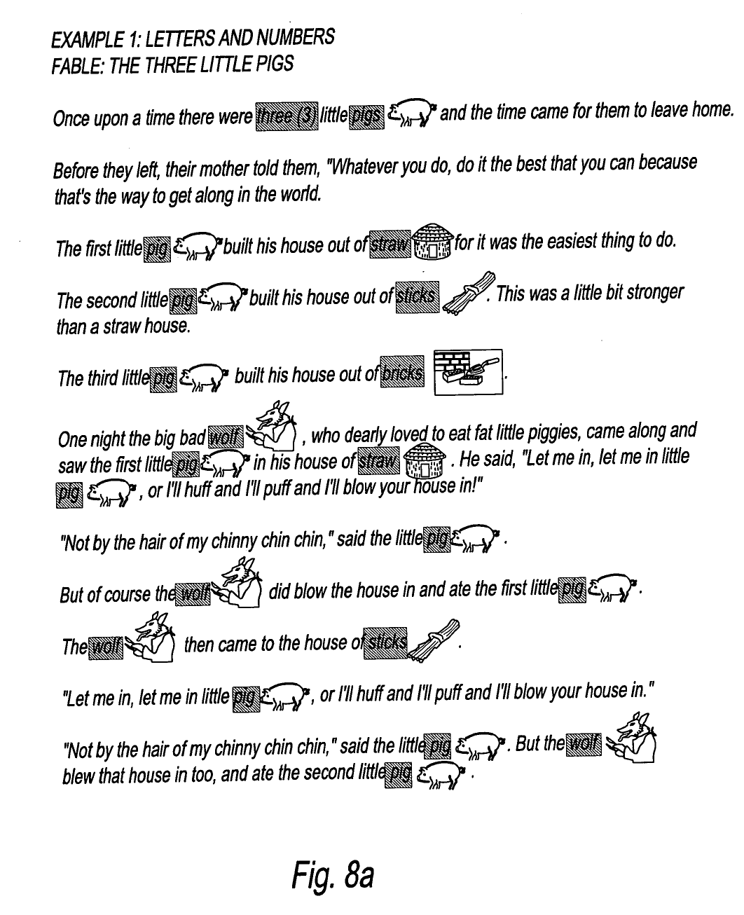

FIG. 7 is another example, namely Example 2, of a reading passage produced by system 100. In FIG. 7, features having the reader's preferred color are represented by grayscale highlights. In Example 2, system 100 provides the reader with a more complex reading opportunity as compared to Example 1, again in the color preference, to include words and numerals and complex combinations of both. The reader, through verbalization, can begin to achieve phonetic aptitude and performance.

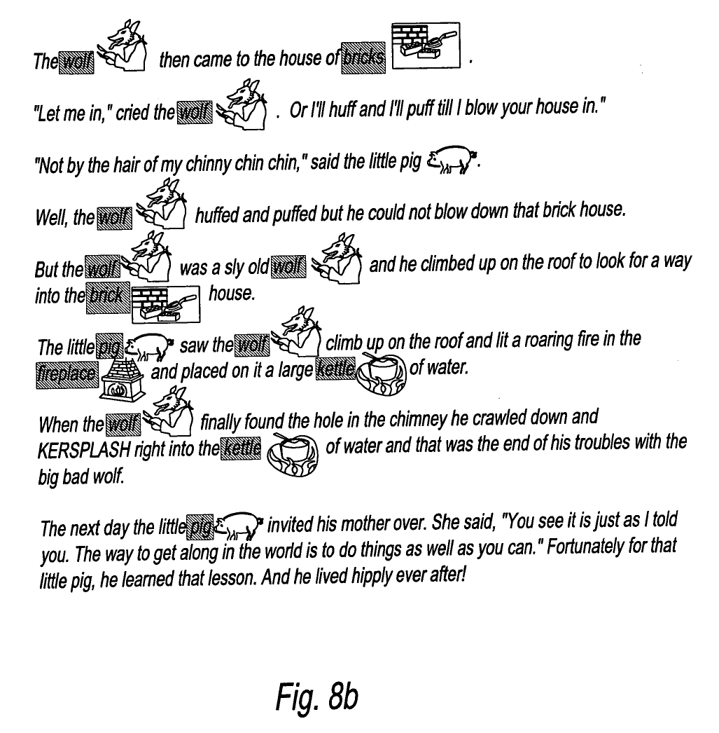

FIG. 8 (represented in two parts designated as FIG. 8a and FIG. 8b) is another example, namely Example 3, of a reading passage produced by system 100. In FIG. 8, features having the reader's preferred color are represented by grayscale highlights. In Example 3, system 100 produces a preferential color for a reader who is now focusing on even more complex words, numerals and symbols to achieve proficiency. The symbols and images now reinforce the words and numerals to accelerate learning and reinforcement. In Example 3, highlighted words use the preferential color. Letters, numerals, symbols or images can also be presented in the preferential color, similarly to the examples shown in FIGS. 2-4.

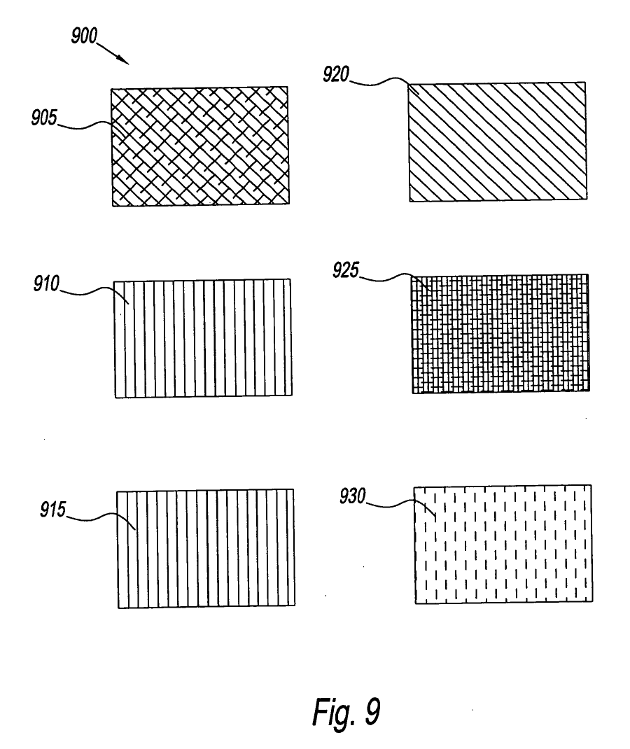

FIG. 9 is an example of a kit 900 for a color preference selection test that system 100 provides, for example, in a direct mailing. Kit 900 includes several sets of different colored rectangles (e.g., an orange rectangle 905, a pink rectangle 910, a red rectangle 915, a green rectangle 920, a yellow rectangle 925, and a blue rectangle 930) that are physical and tactile, such as paper. An Intermediary administers the test by putting the rectangles on a surface and asking the Reading Target Recipient to select his/her color preference or favorite rectangle. The test of the person can include a presentation to the person of any of (a) a palette of two colors, (b) a palette of a plurality of colors, (c) a color wheel, (d) a shape that includes the color, and/or (e) an image that includes the color. The test may also include eliminating a color for which the person does not have an affinity.

Thus, system 100 (a) obtains a result of a test of a person, wherein the result indicates a color for which the person has an affinity, and (b) prepares, or issues a communication that initiates preparation of a document that includes an element having a feature having the color. Thereafter, system 100 delivers the document to the person. The element can be any of a letter, a syllable, a word, a numeral, a shape, an image, a sign or a symbol. The feature can be any of an outline of the element, a body of the element, a background of the element, and a perimeter inside of which the element is situated. The delivery can include either of printing the document on a physical media, or displaying the document on an electronic display.

The test of the person can include a presentation to the person of any of (a) a palette of two colors, (b) a palette of a plurality of colors, (c) a color wheel, (d) a shape that includes the color, and/or (e) an image that includes the color. The test may also include eliminating a color for which the person does not have an affinity.

Prior to preparing the document, or prior to issuing the instruction to prepare the document, system 100 may obtain information about the person, and select the element based on the information. The information can be indicative of an age of the person, or an intellectual aptitude of the person.

By way of example, the element may be a word that identifies an object, wherein the document includes an image of the object adjacent to the word. The image may or may not include the preferential color.

Steps associated with the processes described herein can be performed in any order, unless otherwise specified or dictated by the steps themselves.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method comprising:
obtaining a result of a test of a person, wherein said result indicates a color for which said person has an affinity; and
preparing a document that includes an element having a feature having said color.

2. The method of claim 1, further comprising delivering said document to said person.

3. The method of claim 1, wherein said preparing comprises an activity selected from the group consisting of:
(a) printing said document on a physical media; and
(b) formatting said document for presentation on an electronic display.

4. The method of claim 1, wherein said test comprises a presentation to said person, selected from the group consisting of:
(a) a palette of two colors;
(b) a palette of a plurality of colors;
(c) a color wheel;
(d) a shape that includes said color; and
(e) an image that includes said color.

5. The method of claim 1, wherein said test includes eliminating a color for which said person does not have an affinity.

6. The method of claim 1, wherein said element is selected from the group consisting of a letter, a syllable, a word, a numeral, a shape, an image, a sign and a symbol.

7. The method of claim 1, wherein said feature is selected from the group consisting of:
(a) an outline of said element;
(b) a body of said element;
(c) a background of said element; and
(d) a perimeter inside of which said element is situated.

8. The method of claim 1, further comprising, prior to said preparing:
obtaining information about said person; and
selecting said element based on said information.

9. The method of claim 8, wherein said information is indicative of a characteristic selected from the group consisting of:
(a) an age of said person; and
(b) an intellectual aptitude of said person.

10. The method of claim 1,
wherein said element is a word that identifies an object,
wherein said document includes an image of said object adjacent to said word, and
wherein said image includes said color.

11. An apparatus comprising a circuit that performs activities of:
obtaining a result of a test of a person, wherein said result indicates a color for which said person has an affinity; and
preparing a document comprising an element having a feature having said color.

12. The apparatus of claim 11, wherein said circuit further performs an activity of delivering said document to said person.

13. The apparatus of claim 11, wherein said preparing comprises an activity selected from the group consisting of:
(a) printing said document on a physical media; and
(b) formatting said document for presentation on an electronic display.

14. The apparatus of claim 11, wherein said test comprises a presentation to said person, selected from the group consisting of:
(a) a palette of two colors;
(b) a palette of a plurality of colors;
(c) a color wheel;
(d) a shape that includes said color; and
(e) an image that includes said color.

15. The apparatus of claim 11, wherein said test includes eliminating a color for which said person does not have an affinity.

16. The apparatus of claim 11, wherein said element is selected from the group consisting of a letter, a syllable, a word, a numeral, a shape, an image, a sign and a symbol.

17. The apparatus of claim 11, wherein said feature is selected from the group consisting of:
(a) an outline of said element;
(b) a body of said element;
(c) a background of said element; and
(d) a perimeter inside of which said element is situated.

18. The apparatus of claim 11, wherein said circuit also performs, prior to said preparing, activities of:
obtaining information about said person; and
selecting said element based on said information.

19. The apparatus of claim 18, wherein said information is indicative of a characteristic selected from the group consisting of:
(a) an age of said person; and
(b) an intellectual aptitude of said person.

20. The apparatus of claim 11,
wherein said element is a word that identifies an object,
wherein said document includes an image of said object adjacent to said word, and
wherein said image includes said color.

21. A storage medium comprising instructions that are readable by a processor, and control said processor to perform activities of:
obtaining a result of a test of a person, wherein said result indicates a color for which said person has an affinity; and
issuing a communication to initiate preparation of a document that includes an element having a feature having said color.

22. The storage medium of claim 21, wherein said instructions further control said processor to perform an activity of delivering said document to said person.

23. The storage medium of claim 21, wherein said preparation comprises an activity selected from the group consisting of:
(a) printing said document on a physical media; and
(b) formatting said document for presentation on an electronic display.

24. The storage medium of claim 21, wherein said test comprises a presentation to said person, selected from the group consisting of:
(a) a palette of two colors;
(b) a palette of a plurality of colors;
(c) a color wheel;
(d) a shape that includes said color; and
(e) an image that includes said color.

25. The storage medium of claim 21, wherein said test includes eliminating a color for which said person does not have an affinity.

26. The storage medium of claim 21, wherein said element is selected from the group consisting of a letter, a syllable, a word, a numeral, a shape, an image, a sign and a symbol.

27. The storage medium of claim 21, wherein said feature is selected from the group consisting of:
(a) an outline of said element;
(b) a body of said element;
(c) a background of said element; and
(d) a perimeter inside of which said element is situated.

28. The storage medium of claim 21, wherein said instructions further control said processor to perform, prior to said preparing, activities of:
obtaining information about said person; and
selecting said element based on said information.

29. The storage medium of claim 28, wherein said information is indicative of a characteristic selected from the group consisting of:
(a) an age of said person; and
(b) an intellectual aptitude of said person.

30. The storage medium of claim 21,
wherein said element is a word that identifies an object,
wherein said document includes an image of said object adjacent to said word, and
wherein said image includes said color.
